(19) United States
(12) Patent Application Publication
(10) Pub. No.: US 2016/0221059 A1
(43) Pub. Date: Aug. 4, 2016

(54) ELECTROMAGNETIC FORMING COIL DEVICE AND METHOD OF MAKING ELECTROMAGNETICALLY FORMED PRODUCT

(71) Applicant: Kabushiki Kaisha Kobe Seiko Sho (Kobe Steel, Ltd.), Kobe-shi (JP)

(72) Inventors: Takashi GOTO, Fujisawa-shi (JP); Kazumasa KAITOKU, Moka-shi (JP); Yoshihaya IMAMURA, Fujisawa-shi (JP)

(73) Assignee: Kabushiki Kaisha Kobe Seiko Sho (Kobe Steel, Ltd.), Kobe-shi (JP)

(21) Appl. No.: 14/965,087

(22) Filed: Dec. 10, 2015

(30) Foreign Application Priority Data
Feb. 3, 2015 (JP) 2015-019662

(51) Int. Cl. B21D 26/14; H01F 41/04; H01F 27/24; H01F 27/28

(52) U.S. Cl. CPC B21D 26/14; H01F 27/2823; H01F 41/04; H01F 27/24

(57) ABSTRACT

An electromagnetic forming coil device includes a conductor coil; and a magnetic field shaper including a tubular portion disposed in the conductor coil, and an end wall portion that extends from a base end portion thereof, which is at one end of the tubular portion in a longitudinal direction, to an extended end toward an axis of the conductor coil, the end wall portion having a cavity surface at the extended end, the cavity surface surrounding a workpiece. The tubular portion and the end wall portion are each divided into sections in the longitudinal direction, and the magnetic field shaper includes insulating layers disposed on the divided sections of each of the tubular portion and the end wall portion and on the cavity surface. The extended end of the end wall portion is disposed at a position protruding outward from a position of the conductor coil in the longitudinal direction.

### BACKGROUND OF THE INVENTION

1. Field of the Invention

The present invention relates to an electromagnetic forming coil device and a method of making an electromagnetically formed product. To be more specific, the present invention relates to an electromagnetic forming coil device and a method of making an electromagnetically formed product that are used to electromagnetically form a portion to be processed of a workpiece.

2. Description of the Related Art

Electromagnetic forming technology is used to expand or compress a pipe made of a conductor. Electromagnetic forming is a method of plastically forming a conductor by using an electromagnetic force. In electromagnetic forming, a high-voltage charge is instantaneously discharged to a conductor coil to generate a strong magnetic field around the conductor coil in a short time. A workpiece disposed in the magnetic field is processed by using a repulsive force generated between the workpiece and the conductor coil.

For example, Japanese Unexamined Patent Application Publication No. 2007-275909 discloses a technology related to an electromagnetic forming coil that can be used for compression forming. The electromagnetic forming coil includes an electromagnetic coil body made by helically winding a conductive wire and a tubular conductor disposed outside of the electromagnetic coil body so as to surround the electromagnetic coil body. Japanese Unexamined Patent Application Publication (Translation of PCT Application) No. 2007-520353 discloses a technology, related to a drive shaft, in which a current is induced by using an electric field shaper and thereby two components are compressively joined together.

According to the disclosure in Japanese Unexamined Patent Application Publication (Translation of PCT Application) No. 2007-520353, a coil is disposed at a position at which the coil does no overlap the magnetic field shaper. Therefore, a magnetic field generated from the coil might influence a portion of the workpiece other than a portion to be processed.

When electromagnetic forming is performed on a workpiece by using existing technologies, an electromagnetic force may be applied to a portion of the workpiece that is not to be processed, and this portion may become deformed.

### SUMMARY OF THE INVENTION

The main object of the present invention is to provide an electromagnetic forming coil device and a method of making an electromagnetically formed product that can reduce occurrence of deformation, due to an electromagnetic force, of a portion of a workpiece other than a portion to be processed when electromagnetic forming is performed.

An electromagnetic forming coil device according to the present invention includes a conductor coil that is helically wound; and a magnetic field shaper including a tubular portion that is disposed in the conductor coil along the coil in a longitudinal direction, and an end wall portion that extends from a base end portion thereof, which is at one end of the tubular portion in the longitudinal direction, to an extended end thereof toward an axis of the conductor coil, the end wall portion having a cavity surface at the extended end, the cavity surface surrounding a workpiece and being formed along an outer periphery of the workpiece. The tubular portion and the end wall portion of the magnetic field shaper are each divided into a plurality of sections in the longitudinal direction, and the magnetic field shaper includes insulating layers disposed on the divided sections of each of the tubular portion and the end wall portion and on the cavity surface. The extended end of the end wall portion extending toward the axis is disposed at a position protruding outward from a position of the conductor coil in the longitudinal direction.

In the electromagnetic forming coil device, the base end portion of the end wall portion may be disposed so as to protrude outward from the position of the conductor coil in the longitudinal direction.

A method of making an electromagnetically formed product according to the present invention uses a magnetic field shaper including a tubular portion, an end wall portion, and insulating layers, the tubular portion being disposed in a conductor coil, which is helically wound, along the coil in a longitudinal direction, the end wall portion extending from a base end portion thereof, which is at one end of the tubular portion in the longitudinal direction, to an extended end thereof toward an axis of the conductor coil, the end wall portion having a cavity surface at the extended end, the cavity surface being formed along an outer periphery of the workpiece, the tubular portion and the end wall portion of the magnetic field shaper each being divided into a plurality of sections in the longitudinal direction, the insulating layers being disposed on the divided sections of each of the tubular portion and the end wall portion and on the cavity surface. The method includes a step of arranging the magnetic field shaper and the workpiece so that the cavity surface surrounds a portion to be processed of the workpiece; a step of disposing the conductor coil around the magnetic field shaper so that the extended end of the end wall portion is located at a position protruding outward from a position of the conductor coil in the longitudinal direction; and a step of passing an electric current through the conductor coil to generate magnetic flux. The portion to be processed of the workpiece is processed by using an electromagnetic force generated by the magnetic flux.

In the method of making an electromagnetically formed product, the conductor coil may be disposed around the magnetic field shaper after the portion to be processed of the workpiece has been surrounded by the cavity surface of the magnetic field shaper.

With the present invention, it is possible to provide an electromagnetic forming coil device and a method of making an electromagnetically formed product that can reduce occurrence of deformation, due to an electromagnetic force, of a portion of a workpiece other than a portion to be processed when electromagnetic forming is performed.

### BRIEF DESCRIPTION OF THE DRAWINGS

FIG. 1 is a schematic longitudinal sectional view illustrating an example of the structure of an electromagnetic forming coil device according to an embodiment of the present invention;

FIG. 2 is a schematic cross-sectional view, taken along a line II-II in FIG. 1, illustrating an example of the structure of the electromagnetic forming coil device according to the embodiment of the present invention;

FIG. 3 is a schematic longitudinal sectional view illustrating an electromagnetically formed product formed by using the electromagnetic forming coil device according to the embodiment of the present invention;

FIG. 4A is a schematic longitudinal sectional view illustrating another example of the structure of an electromagnetic forming coil device according to the embodiment of the present invention;

FIG. 4B is a schematic longitudinal sectional view illustrating another example of the structure of an electromagnetic forming coil device according to the embodiment of the present invention;

FIG. 5 is a schematic longitudinal sectional view illustrating still another example of the structure of an electromagnetic forming coil device according to the embodiment of the present invention;

FIG. 6 is a cross-sectional view corresponding to FIG. 2 and illustrating an example of the structure of the electromagnetic forming coil device according to the embodiment of the present invention, in which slit portions of the electromagnetic forming coil device are shown;

FIG. 7 is a cross-sectional view corresponding to FIG. 2 and illustrating an example of the structure of the electromagnetic forming coil device according to the embodiment of the present invention, in which insulating layers of the electromagnetic forming coil device according to the embodiment of the present invention are shown;

FIG. 8 is a cross-sectional view corresponding to FIG. 2 and illustrating still another example of the structure of the electromagnetic forming coil device according to the embodiment of the present invention;

FIG. 9 is a schematic longitudinal sectional view illustrating an example of the structure of an electromagnetic forming coil device to be compared with the electromagnetic forming coil device according to the embodiment of the present invention;

FIG. 10 is a schematic longitudinal sectional view illustrating another example of the structure of an electromagnetic forming coil device to be compared with the electromagnetic forming coil device according to the embodiment of the present invention; and

FIG. 11 is a schematic longitudinal sectional view illustrating an electromagnetically formed product that can be formed by using the electromagnetic forming coil devices shown in FIGS. 9 and 10.

### DESCRIPTION OF THE PREFERRED EMBODIMENTS

Hereinafter, embodiments of the present invention will be described in detail. In each of the embodiments described below, an example in which two pipe-shaped workpieces are processed by electromagnetic forming will be described. However, the present invention is not limited to the embodiments described below.

An electromagnetic forming coil device according to an embodiment of the present invention includes a conductor coil that is helically wound and a magnetic field shaper.

The magnetic field shaper includes a tubular portion that is disposed in the conductor coil along the coil in the longitudinal direction, and an end wall portion that extends from a base end portion thereof, which is at one end of the tubular portion in the longitudinal direction, to an extended end thereof toward the axis of the conductor coil. The end wall portion has a cavity surface at the extended end, the cavity surface surrounding a workpiece and being formed along an outer periphery of the workpiece. The tubular portion and the end wall portion of the magnetic field shaper are each divided into a plurality of sections in the longitudinal direction. The magnetic field shaper includes insulating layers disposed on the divided sections of each of the tubular portion and the end wall portion and on the cavity surface.

In the electromagnetic forming coil device according to the present embodiment, the extended end of the end wall portion is disposed so as to protrude outward from the position of the conductor coil in the longitudinal direction.

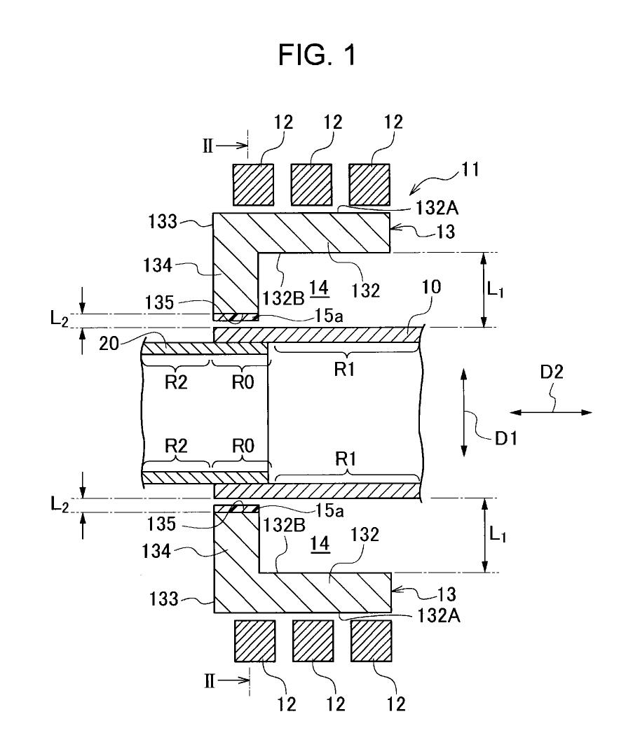

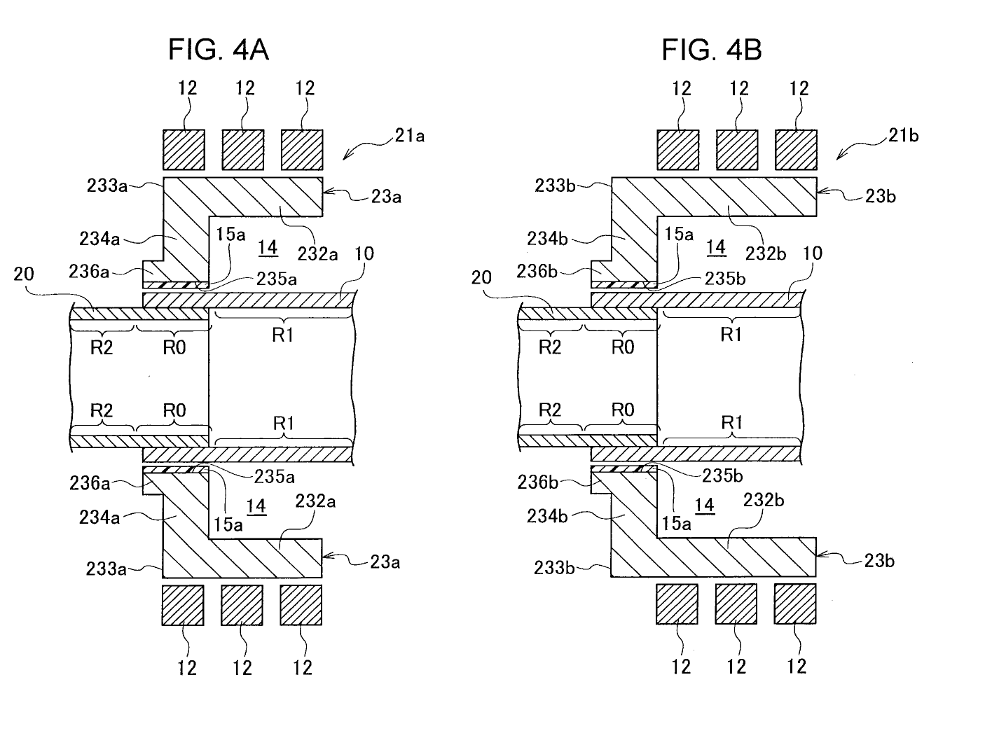

Referring to FIGS. 1 to 8, the electromagnetic forming coil device according to the present embodiment will be described. First, referring to FIGS. 1 to 3, the electromagnetic forming coil device according to the present embodiment and a method of making an electromagnetically formed product will be described. Next, referring to FIGS. 4 to 8, the structure of the electromagnetic forming coil device according to the present embodiment will be described further.

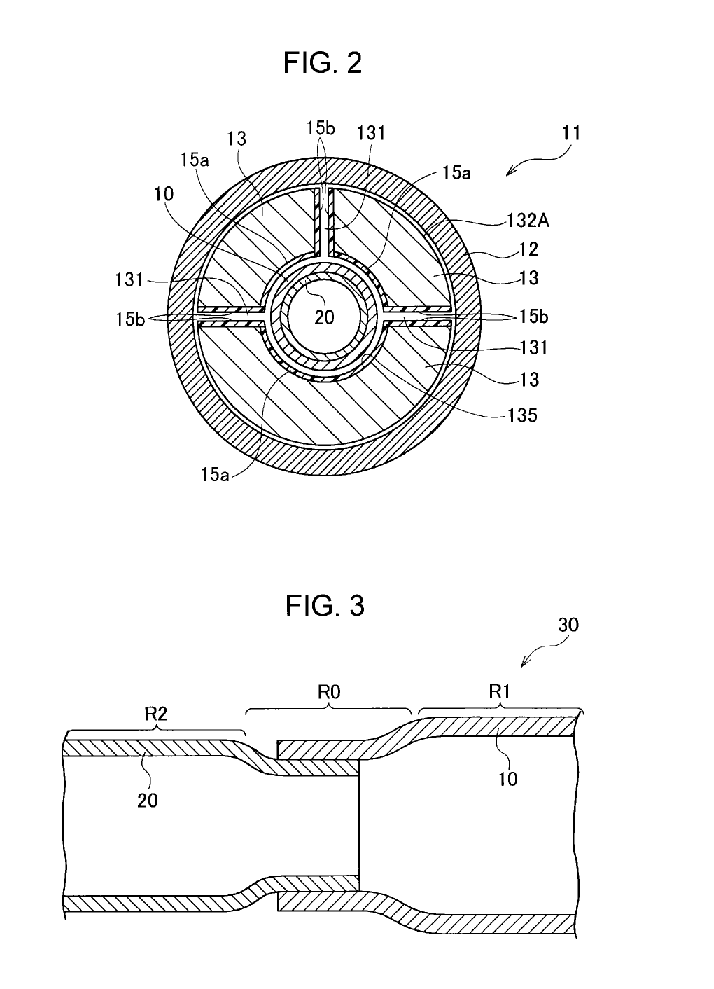

FIG. 1 is a schematic longitudinal sectional view illustrating an example of the structure of an electromagnetic forming coil device 11 according to the present embodiment. FIG. 2 is a schematic cross-sectional view taken along a line II-II in FIG. 1. FIG. 3 is a schematic longitudinal sectional view illustrating an example of the structure of an electromagnetically formed product formed by using the electromagnetic forming coil device according to the present embodiment.

As illustrated in FIG. 1, the electromagnetic forming coil device 11 according to the present embodiment includes a conductor coil 12 that is helically wound and a magnetic field shaper 13.

For example, the conductor coil 12 may be made by winding a conductive wire around a shaft, such as a bobbin, helically, or preferably, solenoidally. The material of the conductive wire is not particularly limited, and any appropriate material used for existing electromagnetic forming coil devices can be used. Examples of the material of the conductive wire include copper, a copper alloy such as chromium copper, and an aluminum alloy. The conductor coil 12 can be connected to an electric circuit (not shown), including a capacitor, a switch, and the like.

The magnetic field shaper 13 as a whole has a substantially tubular shape and includes a tubular portion 132, which is the tubular peripheral wall. The tubular portion 132, which has an outer surface 132A and an inner surface 132B, is disposed in the conductor coil 12 along the coil in the longitudinal direction (see the direction of an arrow D2 in FIG. 1). The meaning of “the tubular portion of the magnetic field shaper is disposed in the conductor coil along the coil in the longitudinal” includes the meaning that, in the longitudinal direction of the tubular portion and the conductor coil, the length of the tubular portion is greater than that of the conductor coil or the length of the conductor coil is substantially the same as that of the tubular portion. Thus, in the longitudinal direction of the tubular portion 132 and the conductor coil 12, the tubular portion 132 is disposed at a position that overlaps the conductor coil 12 and the conductor coil 12 is disposed at a position that does not extend beyond the magnetic field shaper 13.

The magnetic field shaper 13 includes an end wall portion 134 that extends from a base end portion 133, which is at one end of the tubular portion 132 in the longitudinal direction (also referred to as the axial direction, see the direction of the arrow D2 in FIG. 1), to an extended end thereof toward the axis of the conductor coil 12 (see an arrow D1 in FIG. 1). The end wall portion 134 of the magnetic field shaper 13 has a cavity surface 135 at the extended end extending toward the axis, the cavity surface 135 surrounding a first workpiece 10 and being formed along the outer periphery of the first workpiece 10. The cavity surface, which is the surface of the extended end of the end wall portion of the magnetic field shaper extending toward the axis, serves as an end surface for forming a portion to be processed of a workpiece (an end surface that is closest to the portion to be processed of the workpiece). In the present disclosure, the end surface is called a cavity surface, because a space formed between the end surface (cavity surface) and the outer surface of the portion to be processed of the workpiece serves as a cavity.

In the present embodiment, because the magnetic field shaper 13 is divided into a plurality of sections, the cavity surface 135 is a combination of surfaces, on the axis side of the end portion 134, of the sections into which the magnetic field shaper 13 is divided.

In the electromagnetic forming coil device 11 according to the present embodiment, the outer surface 132A of the tubular portion 132 is disposed in the conductor coil 12 so as to face the conductor coil 12. The inner surface 132B of the tubular portion 132, which is located inside of the outer surface 132A, is disposed so as to face the first workpiece 10.

Preferably, the outer surface 132A of the tubular portion 132 of the magnetic field shaper 13 has a cylindrical shape corresponding to the shape of the conductor coil 12 so that magnetic flux generated from the conductor coil 12 can be concentrated onto the magnetic field shaper 13. The cross-sectional shape of the inner surface 132B of the tubular portion 132 is not particularly limited. Generally, the cross-sectional shape is the same as that of the outer surface 132A. The cross-sectional shape of the inner surface 132B of the tubular portion 132 may be a shape corresponding to the first workpiece 10 disposed in a space 14 of the magnetic field shaper 13.

The extended end of the end wall portion 134, extending from the base end portion 133 of the tubular portion 132 toward the axis of the conductor coil 12, is disposed so as to protrude from the position of the conductor coil 12 outward in the longitudinal direction of the tubular portion 132. At this position, the cavity surface 135 of the end wall portion 134 is disposed so as to face a portion R0 to be processed of the first workpiece 10. When performing electromagnetic forming, magnetic flux generated from the conductor coil 12 passes through the tubular portion 132 and the end wall portion 134 of the magnetic field shaper 13, and is concentrated toward the cavity surface 135 at the extended end of the end wall portion 134. Thus, it is possible to locally concentrate an electromagnetic force onto the portion R0 to be processed of the first workpiece 10.

In the electromagnetic forming coil device 11 illustrated in FIG. 1, a part of the extended end of the end wall portion 134 extending toward the axis of the conductor coil 12 and a part of the cavity surface 135 at the extended end are disposed so as to protrude outward from the position of the conductor coil 12 in the longitudinal direction. As in this case, it is sufficient that at least a part of the extended end of the end wall portion 134 and at least a part of the cavity surface 135 at the extended end may be disposed so as to protrude outward from the position of the conductor coil 12 in the longitudinal direction of the tubular portion 132. Accordingly, the magnetic field shaper 13 may be structured in such a way that the entirety of the extended end of the end wall portion 134 extending toward the axis of the conductor coil 12 and the entirety of the cavity surface 135 at the extended end may be disposed so as to protrude outward from the position of the conductor coil 12 in the longitudinal direction.

In the magnetic field shaper 13 according to the present embodiment, the end wall portion 134, which extends from the base end portion 133 of the tubular portion 132 toward the axis of the conductor coil 12, forms a space 14 between the inner surface 132B of the tubular portion 132 and the first workpiece 10. The space 14 has a sufficient distance between the inner surface 132B of the tubular portion 132 and the first workpiece 10 so that magnetic flux is not applied to the first workpiece 10. Accordingly, it is possible to easily block magnetic flux by using the space 14. Therefore, magnetic flux toward a portion of the first workpiece 10 other than the portion R0 to be processed (hereinafter, referred to as a “portion R1 not to be processed”) can be suppressed, and it is possible to reduce the influence of magnetic flux generated by the conductor coil 12 during electromagnetic forming on the portion R1 not to be processed of the first workpiece 10.

The size of the space 14 in the magnetic field shaper 13 may vary in accordance with, for example, the sizes and the materials of the first workpiece 10 and a second workpiece 20 (hereinafter referred to as “workpieces 10 and 20”). Preferably, the size of the space 14 is such that the space 14 can block magnetic flux toward the first workpiece 10.

For example, when the first workpiece 10 is a cylindrical member made of a 7000 series aluminum alloy and having an outside diameter of 40 mm and a thickness of 2 mm, the size of the space 14 may be as follows. In order to block magnetic flux, in the longitudinal sectional view shown in FIG. 1, the distance L1 from the inner surface 132B of the tubular portion 132 of the magnetic field shaper 13 to the outer surface of the first workpiece 10 is preferably 3 mm or more, more preferably 5 mm or more, and further preferably 10 mm or more. In order to make magnetic flux be easily concentrated onto the cavity surface 135 of the end wall portion 134 of the magnetic field shaper 13, the distance L1 is preferably 100 mm or less, more preferably 50 mm or less, and further preferably 30 mm or less. In order to apply an electromagnetic force to the portion R0 to be processed of the first workpiece 10, the distance L2 from the end surface of the cavity surface 135 of the magnetic field shaper 13 to the outer surface of the first workpiece 10 is preferably in the range of, for example, 0.1 to 2 mm.

As illustrated in FIG. 2, the magnetic field shaper 13 according to the present embodiment has slit portions 131 extending in the longitudinal direction of the tubular portion 132 (see the direction of the arrow D2 in FIG. 1). The slit portions 131 connect the outer surface 132A of the tubular portion 132, the inner surface 132B of the tubular portion 132, and the cavity surface 135 of the end wall portion 134 to each other. In the magnetic field shaper 13, due to the presence of the slit portions 131, each of the tubular portion 132 and the end wall portion 134 is divided into a plurality of sections in the longitudinal direction.

The magnetic field shaper 13 illustrated FIG. 2 includes three slit portions 131 in the circumferential direction of the magnetic field shaper 13, so that the magnetic field shaper 13 is divided into three sections in the circumferential direction.

The slit portions 131 may extend over the entirety of or a part of the length of the magnetic field shaper 13, including the tubular portion 132 and the end wall portion 134, in the axial direction of the magnetic field shaper 13 (see the direction of the arrow D2 in FIG. 1).

Because the magnetic field shaper 13 includes the slit portions 131 extending in the axial direction, when an electric current is applied to the conductor coil 12 to perform electromagnetic forming, it is possible to form a closed circuit of an induced current circulating through the outer surface 132A and the inner surface 132B of the magnetic field shaper 13.

Due to the closed circuit of the induced current, flow of an induced current is generated also on the inner surface 132B side of the magnetic field shaper 13, and magnetic repulsion between the cavity surface 135 of the end wall portion 134 of the magnetic field shaper 13 and the outer surface of the first workpiece 10 occurs. As a result, it is possible to compressively form the portion R0 to be processed of the first workpiece 10.

The magnetic field shaper 13 includes insulating layers 15b, which are disposed on the divided sections of each of the tubular portion 132 and the end wall portion 134, to be specific, facing surfaces of the divided sections that face each other with the slit portions 131 therebetween. The magnetic field shaper 13 includes insulating layers 15a on the cavity surface 135 of the end wall portion 134.

The materials and the like of the insulating layers 15a and 15b are not particularly limited. The insulating layers 15a and 15b may be made of, for example, a resin or a rubber. The insulating layers 15a and 15b can be formed by covering, with a resin film or a rubber film, the surface of the cavity surface 135 of the end wall portion 134 and the facing surfaces facing each other with the slit portion 131 therebetween. The materials of the insulating layers 15a and 15b are not particularly limited. Examples of the materials include a fluororesin, an acrylic resin, a urethane resin, a vinyl chloride resin, an epoxy resin, and a silicone resin.

Because the insulating layers 15a and 15b are disposed on the divided sections of each of the tubular portion 132 and the end wall portion 134 of the magnetic field shaper 13 and on the cavity surface 135 of the end wall portion 134, it is possible to suppress occurrence of a spark in the slit portions 131 or on the cavity surface 135. Therefore, the electromagnetic forming coil device 11 including the magnetic field shaper 13 can be used more safely.

The material of the magnetic field shaper 13 is not particularly limited, as long as the magnetic field shaper 13 can generate an induced current from magnetic flux generated from the conductor coil 12 and can concentrate the magnetic flux. Examples of such a material include, for example, copper, a chromium-copper alloy, a beryllium-copper alloy, a silver-copper alloy, aluminum, and a 6000 series aluminum alloy. From such a conductive material, the magnetic field shaper 13 can be made to have a substantially tubular shape having the slit portion 131. Because the shape of the magnetic field shaper 13 is substantially tubular, the magnetic field shaper 13 can be disposed in the conductor coil 12 so as to be substantially coaxial with the conductor coil 12. In this case, the magnetic field shaper 13 is disposed so that the outer surface 132A of the tubular portion 132 faces the inner periphery of the conductor coil 12 and so that the inner surface 132B of the tubular portion 132 and the cavity surface 135 of the end wall portion 134 face the outer surface of the first workpiece 10.

As described above, the conductor coil 12 of the electromagnetic forming coil device 11, including the magnetic field shaper 13, according to the present embodiment may be connected to an electric circuit (not shown) including a capacitor and a switch. By structuring the electric circuit so that the capacitor is discharged when the switch, which is connected to a power source, is turned on, it is possible to supply a large pulse current from the electric circuit to the conductor coil 12.

When a large pulse current flows through the conductor coil 12, magnetic flux generated from the conductor coil 12 is concentrated onto the cavity surface 135 of the end wall portion 134 of the magnetic field shaper 13. As a result, an induced current is generated in the first workpiece 10 disposed in the magnetic field shaper 13. Due to interaction between the induced current and the electromagnetic field, a compressive force (electromagnetic force) is applied to the portion R0 to be processed of the first workpiece 10, which is disposed at a position corresponding to the cavity surface 135 of the end wall portion 134 of the magnetic field shaper 13. Thus, as illustrated in FIG. 3, the portion R0 to be processed of the first workpiece 10 is compressed, and an electromagnetically formed product 30, in which the first workpiece 10 and the second workpiece 20 are clinched to each other, can be obtained.

In the electromagnetic forming coil device 11 according to the present embodiment, the conductor coil 12 and the magnetic field shaper 13 are disposed as described above. Therefore, by using the electromagnetic forming coil device 11, it is possible to obtain an electromagnetically formed product 30 in which the portions R1 and R2 not to be processed of the workpieces 10 and 20 have substantially no deformation.

The electromagnetically formed product 30 can be made by using a method of making an electromagnetically formed product according to the present embodiment, which uses the magnetic field shaper 13.

In the method of making an electromagnetically formed product, the electromagnetic forming coil device 11 described above can be used. In this method, as described below, the conductor coil 12 can be disposed after the workpieces 10 and 20 have been surrounded by the cavity surface 135 of the end wall portion 134 of the magnetic field shaper 13. Therefore, it can be said that the conductor coil 12 and the magnetic field shaper 13 are used in the method of making an electromagnetically formed product according to the present embodiment.

In the method of making an electromagnetically formed product according to the present embodiment, the magnetic field shaper 13 described above, which includes the tubular portion 132, the end wall portion 134, and the insulating layers 15a and 15b is used.

The method of making an electromagnetically formed product according to the present embodiment includes a step of arranging the magnetic field shaper 13 and the first workpiece 10 so that the cavity surface 135 of the end wall portion 134 surrounds the portion R0 to be processed of the first workpiece 10. When clinching the first workpiece 10 and the second workpiece 20 to each other as in the present embodiment, preferably, the second workpiece 20 is inserted into the first workpiece 10 beforehand.

The method of making an electromagnetically formed product according to the present embodiment includes a step of disposing the conductor coil 12 around the magnetic field shaper 13 so that the extended end of the end wall portion 134 is located at a position protruding outward from the position of the conductor coil 12 in the longitudinal direction (axial direction) of the tubular portion 132. In this step, the cavity surface 135, which is at the extended end of the end wall portion 134 of the magnetic field shaper 13, is disposed so that at least a part thereof is located at a position protruding outward from an end of the conductor coil 12 in the longitudinal direction.

The method includes a step of passing an electric current through the conductor coil 12 to generate magnetic flux. By using an electromagnetic force generated by the magnetic flux, the portion R0 to be processed of the first workpiece 10 can be processed.

In the method of making an electromagnetically formed product according to the present embodiment, preferably, the conductor coil 12 is disposed around the magnetic field shaper 13 after the workpieces 10 and 20 have been surrounded by the cavity surface 135 of the end wall portion 134 of the magnetic field shaper 13. By disposing the conductor coil 12 after the workpieces 10 and 20 have been disposed, the position of the cavity surface 135 relative to the position of the conductor coil 12 in the longitudinal direction of the tubular portion 132 (a distance by which the cavity surface 135 protrudes outward in the longitudinal direction) can be easily adjusted.

Preferably, the shapes of the first workpiece 10 and the second workpiece 20, which are to be processed by using the electromagnetic forming method using the electromagnetic forming coil device 11 according to the present embodiment, are substantially cylindrical shapes, substantially rectangular tubular shapes, or substantially polygonal tubular shapes. Each of the workpieces may have a non-tubular shape, such as a plate-like shape or a bar-like shape.

The workpiece may be a bracket member including a tubular body and a rib portion, which protrudes from the outer surface of the tubular body outward (toward the magnetic field shaper or toward the conductor coil). Preferably, the rib portion of the bracket member is formed so as to protrude from a base end portion thereof on a part of the outer surface of the tubular body in the circumferential direction. Preferably, the rib portion is formed on the outer surface of the tubular body along the axial direction. In such a bracket member, due to the presence of the rib portion, the rigidity of a part of the tubular body near the base end portion of the rib portion is higher than those of the other parts of the tubular body. When such a bracket member is used as the first workpiece, the part of the tubular body near the base portion of the rib portion, which has a high rigidity, is compressed by a smaller amount than the other parts of the tubular portion, and therefore nonuniform compression occurs in the circumferential direction of the tubular body. As a result, it is possible to make the bracket member (first workpiece) not to be easily extracted from the second workpiece.

Regarding the materials of the first workpiece 10 and the second workpiece 20, it is sufficient that the material of at least the first workpiece 10, which is disposed outside, is a material that can be plastically formed by electromagnetic forming. Preferably, the material of the first workpiece 10 is a metal having high conductivity, such as copper, aluminum, or an aluminum alloy; and more preferably a 2000 series, a 6000 series, or a 7000 series aluminum alloy. The material of the second workpiece 20 may be any of the aforementioned metals having high conductivity or a steel, so that the second workpiece 20 can be plastically formed easily by electromagnetic forming. It is also possible to process and deform the second workpiece 20 by deforming the first workpiece 10 by using an electromagnetic force. Therefore, the material of the second workpiece 20 may be a ceramic, a plastic, a rubber, or the like.

As described above in detail, in the electromagnetic forming coil device 11 according to the present embodiment, the magnetic field shaper 13 includes the tubular portion 132 disposed in the conductor coil 12 along the conductor coil 12 in the longitudinal direction; and the end wall portion 134 extending from the base end portion 133, which is at one end of the tubular portion 132, to the extended end toward the axis of the conductor coil 12. The extended end of the end wall portion 134 extending toward the axis of the conductor coil 12 is disposed at a position protruding outward from the position of the conductor coil 12 in the longitudinal direction of the conductor coil 12. With such structures, while concentrating magnetic flux generated by the conductor coil 12 onto the cavity surface 135 at the extended end of the end wall portion 134, it is possible to suppress magnetic flux toward the portion R1 not to be processed of the first workpiece 10 and magnetic flux toward the portion R2 not to be processed of the second workpiece 20. As a result, it is possible to obtain the electromagnetically formed product 30, in which the portion R0 to be processed of the first workpiece 10 is compressed, the first workpiece 10 and the second workpiece 20 are clinched to each other, and the portion R1 not to be processed of the first workpiece 10 and the portion R2 not to be processed of the second workpiece 20 have substantially no deformation.

In the electromagnetic forming coil device 11 according to the present embodiment, the tubular portion 132 and the end wall portion 134 are each divided into a plurality of sections in the longitudinal direction of the conductor coil 12 (the longitudinal direction of the tubular portion 132), and the insulating layers 15b are disposed on the divided sections. Moreover, in the electromagnetic forming coil device 11, the insulating layer 15a is disposed also on the cavity surface 135 of the end wall portion 134. With such structures, even when a large pulse current flows through the conductor coil 12 during electromagnetic forming, it is possible to prevent occurrence of a spark on the divided sections of the tubular portion 132 and the end wall portion 134 (the slit portions 131) or on the cavity surface 135 of the end wall portion 134. Therefore, the electromagnetic forming coil device 11 can be more safely used.

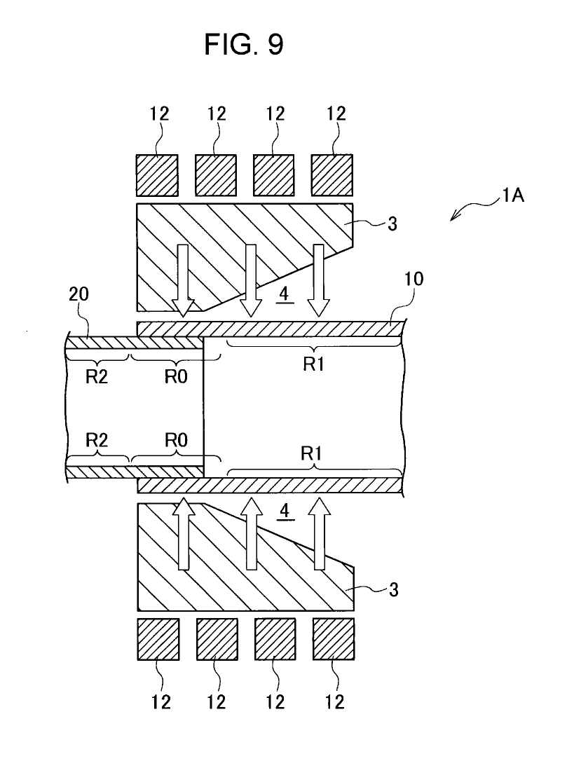

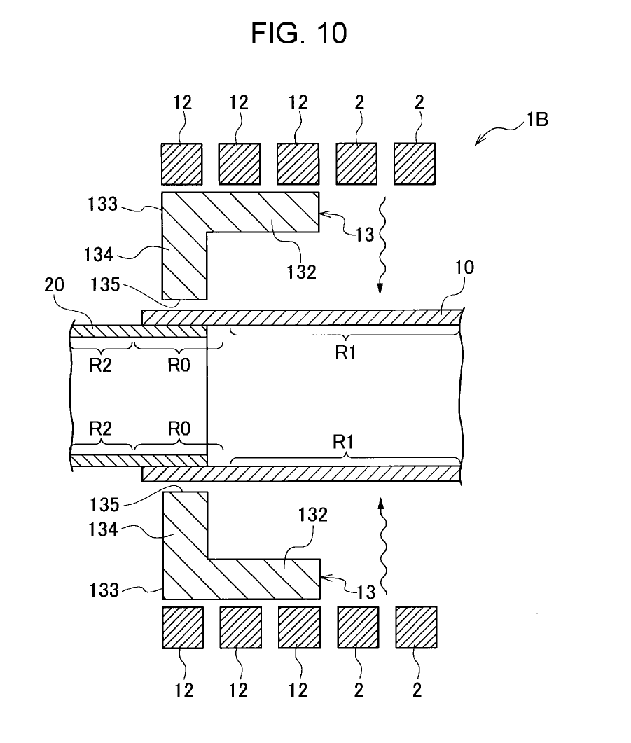

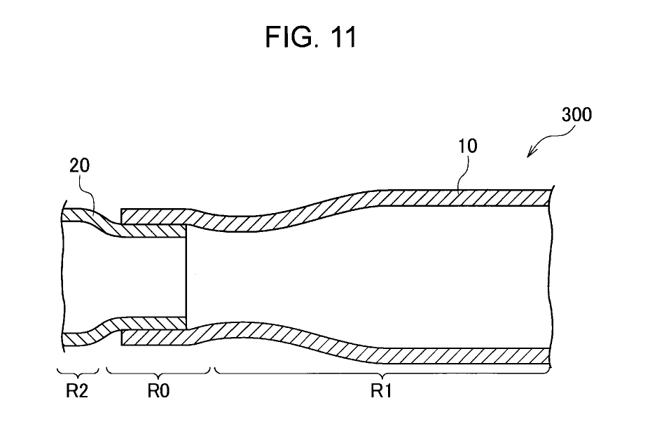

In contrast, when electromagnetic forming is performed by using a device having a structure in which the portion R1 not to be processed of the first workpiece 10 is influenced by a magnetic flux, the portion R1 not to be processed of the first workpiece 10 may become deformed undesirably. FIGS. 9 and 10 illustrate examples of the structures of such a device. FIG. 9 is a schematic longitudinal sectional view illustrating an example of the structure of an electromagnetic forming coil device 1A to be compared with the electromagnetic forming coil device 11 according to the present embodiment. FIG. 10 is a schematic longitudinal sectional view illustrating an example of the structure of another electromagnetic forming coil device 1B to be compared with the electromagnetic forming coil device 11 according to the present embodiment. FIG. 11 is a schematic longitudinal sectional view illustrating an electromagnetically formed product 300 that can be formed by using the electromagnetic forming coil devices shown in FIGS. 9 and 10.

The electromagnetic forming coil device 1A illustrated in FIG. 9 includes a magnetic field shaper 3 that has a substantially trapezoidal shape in a longitudinal sectional view, and the magnetic field shaper 3 forms a space 4 between the magnetic field shaper 3 and the first workpiece 10. However, the electromagnetic forming coil device 1A does not have a structure corresponding to the end wall portion of the magnetic field shaper 3 described above. Therefore, the space 4 is small, and magnetic flux toward the portion R1 not to be processed of the first workpiece 10 cannot be easily suppressed (see blank arrow in FIG. 9).

The electromagnetic forming coil device 1B illustrated in FIG. 10 includes a conductor coil 2 at a position protruding beyond the position of the magnetic field shaper 13 (and the tubular portion 132 of the magnetic field shaper 13). With the electromagnetic forming coil device 1B, because the tubular portion 132 is not disposed along the conductor coils 2 and 12 in the longitudinal direction (the conductor coil 2 is not disposed at a position overlapping the tubular portion 132 of the magnetic field shaper 13), the portion R1 not to be processed of the first workpiece 10 may be influenced by magnetic flux from the conductor coil 2 (see wave-shaped arrows in FIG. 10).

When electromagnetic forming of the workpieces 10 and 20 is performed by using the electromagnetic forming coil devices 1A and 1B shown in FIGS. 9 and 10, an electromagnetic force is likely to be applied also to the portion R1 not to be processed of the first workpiece 10. As a result, as in the electromagnetically formed product 300 illustrated in FIG. 11, the portion R1 not to be processed of the first workpiece 10 might become deformed undesirably. In contrast, with the electromagnetic forming coil device 11 according to the present embodiment described above, it is possible to avoid problems that might occur due to the electromagnetic forming coil devices 1A and 1B.

Next, referring to FIGS. 4 to 8, examples of structures that the magnetic field shaper according to the present invention can have, besides the aforementioned structure of the magnetic field shaper 13, will be described.

Regarding the magnetic field shapers and the electromagnetic forming coil devices described below, elements that are the same as those of the magnetic field shaper 13 and the electromagnetic forming coil device 11 described above will be denoted by the same numerals and redundant descriptions of such elements will be omitted. Description of a method of making an electromagnetically formed product using the magnetic field shapers will be omitted, because it is the same the method of forming the electromagnetically formed product 30 described above.

FIGS. 4A and 4B are schematic longitudinal sectional views illustrating the structures of electromagnetic forming coil devices 21a and 21b according to the embodiment of the present invention. As illustrated in FIGS. 4A and 4B, the electromagnetic forming coil devices 21a and 21b include conductor coils 12 and magnetic field shapers 23a and 23b disposed in the conductor coils 12. As with the magnetic field shaper 13 described above, the magnetic field shapers 23a and 23b include tubular portions 232a and 232b disposed along the conductor coils 12 in the longitudinal direction; and end wall portions 234a and 234b extending from base end portions 233a and 233b, which are at ends of the tubular portions 232a and 232b, to extended ends thereof toward the axes of the conductor coils 12. Cavity surfaces 235a and 235b of the end wall portions 234a and 234b are formed along the outer peripheries of the first workpieces 10 so as to face the portions R0 to be processed of the first workpieces 10.

The magnetic field shapers 23a and 23b differ from the magnetic field shaper 13 described above in that the magnetic field shapers 23a and 23b include flange portions 236a and 236b. The flange portions 236a and 236b are formed so as to protrude outward in the longitudinal directions of the tubular portions 232a and 232b (axial directions) from the extended ends of the end wall portions 234a and 234b extending toward the axes of the conductor coils 12. The flange portions 236a and 236b of the magnetic field shapers 23a and 23b can be formed so as to be continuous with the end wall portions 234a and 234b.

In the electromagnetic forming coil device 21a illustrated in FIG. 4A, the cavity surface 235a at the extended end of the end wall portion 234a of the magnetic field shaper 23a is disposed so as to protrude outward from the position of the conductor coil 12 in the longitudinal direction by the length of the flange portion 236a.

In the electromagnetic forming coil device 21b illustrated in FIG. 4B, the base end portion 233b of the end wall portion 234b of the magnetic field shaper 23b is disposed so as to protrude outward from the position of an end of the conductor coil 12 in the longitudinal direction of the conductor coil 12 (the longitudinal direction of the tubular portion 232b). Thus, the entirety of the end wall portion 234b is located outward from the position of the conductor coil 12 in the longitudinal direction of the conductor coil 12 (the longitudinal direction of the tubular portion 232b). Accordingly, the cavity surface 235b at the extended end of the end wall portion 234b is located outward from the position of an end of the conductor coil 12 in the longitudinal direction. The end wall portion 234b of the magnetic field shaper 23b may be partially disposed outward from the position of the end of the conductor coil 12 in the longitudinal direction.

With the electromagnetic forming coil devices 21a and 21b according to the present embodiment, which are illustrated in FIGS. 4A and 4B, the magnetic field shapers 23a and 23b including the flange portions 236a and 236b can easily concentrate magnetic flux generated by the conductor coils 12 toward the flange portions 236a and 236b of the magnetic field shapers 23a and 23b. Therefore, by disposing the portions R0 to be processed of the first workpieces 10 so as to face the cavity surfaces 235a and 235b of the end wall portions 234a and 234b, it is possible to locally concentrate electromagnetic forces onto the portions R0 to be processed. Influence of magnetic flux on the portions R1 not to be processed of the first workpieces 10 can be suppressed. Thus, with each of the electromagnetic forming coil devices 21a and 21b, in addition to the effects and the advantages that can be obtained by using the electromagnetic forming coil device 11 described above, it is possible to more easily process the portion R0 to be processed of the first workpiece 10 and to further suppress deformation of the portion R1 not to be processed. Furthermore, with the electromagnetic forming coil device 21b illustrated in FIG. 4B, because the base end portion 233b of the end wall portion 234b of the magnetic field shaper 23b is disposed so as to protrude outward from the position of the conductor coil 12 in the longitudinal direction, it is possible to further suppress deformation of the portion R1 not to be processed.

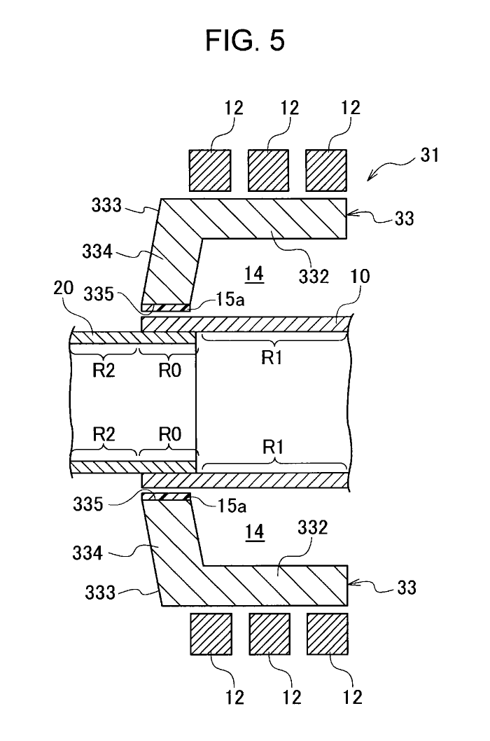

FIG. 5 is a schematic longitudinal sectional view illustrating an example of the structure of an electromagnetic forming coil device 31 according to the embodiment of the present invention. As illustrated in FIG. 5, the electromagnetic forming coil device 31 according to the present embodiment includes a conductor coil 12, and a magnetic field shaper 33 disposed in the conductor coil 12. As with the magnetic field shaper 13 described above, the magnetic field shaper 33 includes a tubular portion 332 disposed along the conductor coil 12 in the longitudinal direction, and an end wall portion 334 extending from a base end portion 333, which is at one end of the tubular portion 332 in the longitudinal direction (axial direction), to an extended end thereof toward the axis of the conductor coil 12. The magnetic field shaper 33 has a cavity surface 335 at the extended end extending toward the axis of the end wall portion 334. The cavity surface 335 of the end wall portion 334 surrounds the first workpiece 10, is formed along the outer periphery of the first workpiece 10, and is disposed so as to face the portion R0 to be processed of the first workpiece 10.

The electromagnetic forming coil device 31 differs from the magnetic field shaper 13 described above in that the end wall portion 334 of the magnetic field shaper 33 is formed so as to protrude at an angle outward in the longitudinal direction of the conductor coil 12 (the longitudinal direction of the tubular portion 332) and toward the axis of the conductor coil 12.

In the electromagnetic forming coil device 31 according to the present embodiment, the end wall portion 334 of the magnetic field shaper 33 protrudes at an angle outward in the longitudinal direction of the conductor coil 12 (the tubular portion 332) and toward the axis of the conductor coil 12 (the tubular portion 332). Therefore, it is possible to concentrate magnetic flux generated by the conductor coil 12 onto the cavity surface 335 of the end wall portion 334. By disposing the portion R0 to be processed of the first workpiece 10 so as to face the cavity surface 335 of the end wall portion 334 of the magnetic field shaper 33, it is possible to locally concentrate an electromagnetic force onto the portion R0 to be processed. Influence of magnetic flux on the portion R1 not to be processed of the first workpiece 10 can be suppressed. Thus, with the electromagnetic forming coil device 31 according to the present embodiment, in addition to the effects and the advantages that can be obtained by using the electromagnetic forming coil device 11 described above, it is possible to more easily process the portion R0 to be processed of the first workpiece 10 and to further suppress deformation of the portion R1 not to be processed.

In the electromagnetic forming coil device 31 illustrated in FIG. 5, as with the electromagnetic forming coil device 21b illustrated in FIG. 4B, the base end portion 333 of the end wall portion 334 of the magnetic field shaper 33 and the entirety of the cavity surface 335 of the end wall portion 334 are disposed so as to protrude outward from the position of the conductor coil 12 in the longitudinal direction of the conductor coil 12 (a tubular portion 223). However, this is not a limitation. For example, a part of the cavity surface 335 of the end wall portion 334 may be disposed so as to protrude outward from the position of an end of the conductor coil 12 in the longitudinal direction. As long as at least a part of the cavity surface 335 of the end wall portion 334 is disposed so as to protrude outward from the position of the end of the conductor coil 12 in the longitudinal direction, the base end portion 333 of the end wall portion 334 may be disposed inside of the conductor coil 12 in the longitudinal direction.

In FIGS. 1, 4A, 4B, and 5, which are used to describe the electromagnetic forming coil devices 11, 21a, 21b, and 31 according to the present embodiment, the sectional shapes of the magnetic field shapers 13, 23a, 23b, and 33 have corners. Each of the corners may be rounded or chamfered. For example, in the magnetic field shaper 13 illustrated in FIG. 1, the outer corner of the outer surface 132A of the magnetic field shaper 13 at the boundary between the tubular portion 132 and the end wall portion 134 is preferably a curved surface. Likewise, the inner corner of the inner surface 132B of the magnetic field shaper 13 at the boundary between the tubular portion 132 and the end wall portion 134 is preferably a curved surface.

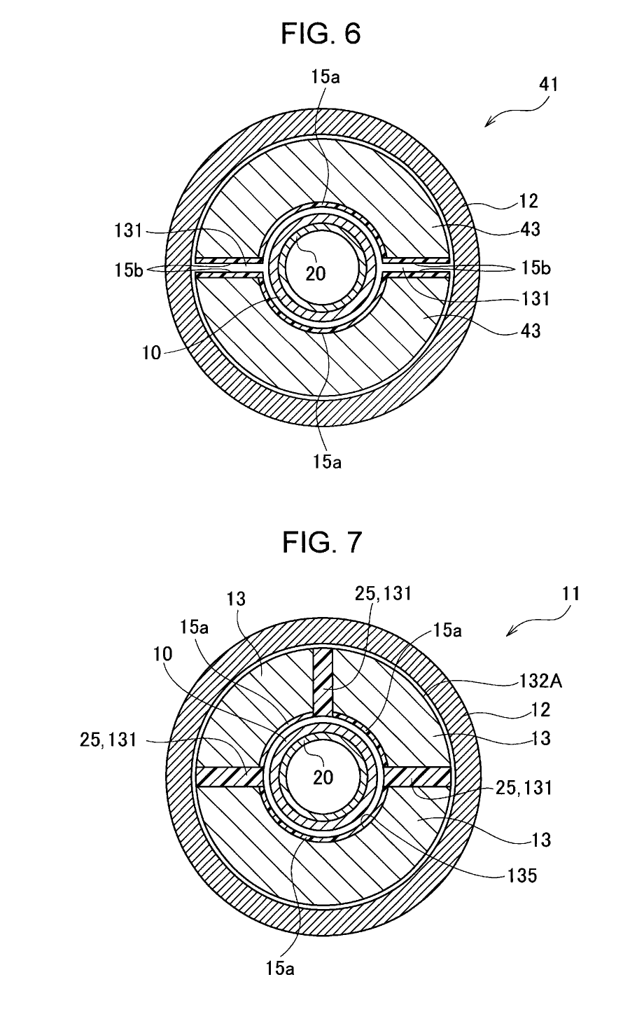

FIG. 6 is a cross-sectional view corresponding to FIG. 2 and illustrating an example of the structure of an electromagnetic forming coil device 41 according to the present embodiment. The electromagnetic forming coil device 11 described above includes three slit portions 131 and the magnetic field shaper 13 is divided into three sections in the circumferential direction. However, the number of slit portions of the magnetic field shaper and the number of sections into which the magnetic field shaper is divided are not particularly limited.

For example, as illustrated in FIG. 6, a magnetic field shaper 43 may include two slit portion 131 in the circumferential direction and may be divided into two sections. The number of the slit portions 131 may be larger than that of the magnetic field shaper 13 described above, and the magnetic field shaper may be divided into four, five, or a larger number of sections in the circumferential direction. Although not shown in the figures, the conductor coil 12 may be divided into a plurality of sections in the circumferential direction.

For example, when a workpiece has flange portions or the like at both ends thereof, after performing electromagnetic forming, it may be difficult to remove an electromagnetically formed product from the electromagnetic forming coil device. In this case, because the magnetic field shaper is divided by the slit portions 131, some of the divided sections of the magnetic field shaper can be removed, and thereby it is possible to easily remove the electromagnetically formed product from the electromagnetic forming coil device. For this purpose, preferably, the conductor coil 12 is also divided into a plurality of sections in the circumferential direction. When the magnetic field shaper and the conductor coil are divided, it is possible to process workpieces having various shapes and to perform electromagnetic forming on wider varieties of workpieces.

FIG. 7 is a cross-sectional view corresponding to FIG. 2 and illustrating another example of the structure of insulating layers formed in the slit portions of the magnetic field shaper. In the magnetic field shaper 13 described above, the insulating layers 15b are disposed on facing surfaces that face each other with the slit portions 131 therebetween. As illustrated in FIG. 7, insulating layers 25 (insulating plates), which are resin plates, rubber plates, or the like, may be disposed in the slit portions 131. The material of the insulating layers 25 is not particularly limited. Examples of the material include a phenol resin, a polypropylene resin, a polyethylene terephthalate resin, a polycarbonate resin, an acrylic resin, a butyl rubber, a silicone rubber, and the like. Each of insulating layers 15a, which are disposed on the cavity surface 135 of the end wall portion of the magnetic field shaper, may be a resin plate, a rubber plate, or the like.

With the structure in which the insulating layers 25 are disposed in the slit portions 131, it is also possible to suppress occurrence a spark in the slit portions 131 and to increase the safety of using the electromagnetic forming coil device 11. Moreover, with this structure, because it is sufficient to dispose the insulating layers 25 in the slit portions 131, the insulating layers 25 can be easily provided in the slit portions 131.

In the embodiment described above, the two workpieces 10 and 20, which are substantially cylindrical, are clinched to each other as workpieces. However, the electromagnetic forming coil device described in each of the embodiments can be used to process a single workpiece, or can be used to process a workpiece having a substantially polygonal tubular shape, a plate-like shape, or a bar-like shape.

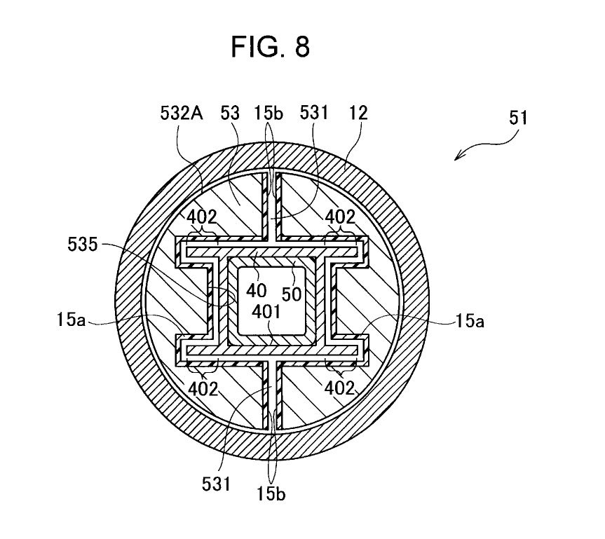

FIG. 8 is a cross-sectional view corresponding to FIG. 2 and illustrating an example of the structure of an electromagnetic forming coil device 51 that is used to electromagnetically form a first workpiece 40 having a substantially rectangular tubular shape. As illustrated in FIG. 8, the electromagnetic forming coil device 51 can be used to electromagnetically form the first workpiece 40 having a substantially rectangular tubular shape. The first workpiece 40, which is an example of the aforementioned bracket member, includes a rectangular tubular portion 401 and rib portions 402, which are formed at four corners (corner portions) of the rectangular tubular portion 401 in a cross-sectional view. The rib portions 402 protrude from base end portions, which are parts of the outer surface of the rectangular tubular portion 401 in the circumferential direction, outward (toward the magnetic field shaper, or toward the conductor coil). Preferably, the rib portions 402 of the first workpiece 40 are disposed on the outer surface of the rectangular tubular portion 401 along the axial direction.

The cross-sectional shape of the rectangular tubular portion 401 of the first workpiece 40 may be a rectangle or a rectangle with rounded corners. Although not shown in FIG. 8, the cross-sectional shape of the rectangular tubular portion 401 may be a polygon (including a polygon that is not axially symmetrical). Preferably, the cross-sectional shape of a second workpiece 50 is the same as that of the rectangular tubular portion 401.

In the first workpiece 40 illustrated in FIG. 8, in a cross-sectional view, the rib portions 402 are formed at the four corners of the rectangular tubular portion 401. Some of the rib portions 402 may be omitted. The rib portions 402 may be formed at two opposite corners or at only one corner. Although not illustrated in FIG. 8, the first workpiece 40 may have a frame-like shape in a plan view. The material of the first workpiece 40 may be the same as that of the first workpiece 10 described above.

Also in the electromagnetic forming coil device 51, each of the tubular portion and the end wall portion of a magnetic field shaper 53 is divided into a plurality of sections in the longitudinal direction of the conductor coil 12 (the axial direction of the tubular portion), and the insulating layers 15a and 15b are disposed on the divided sections and on a cavity surface 535 of the end wall portion.

To be specific, as illustrated in FIG. 8, the magnetic field shaper 53 of the electromagnetic forming coil device 51 includes two slit portions 531 at positions corresponding to substantially the centers of two of the four sides of the rectangular tubular portion 401 of the first workpiece 40. The magnetic field shaper 53 includes the insulating layers 15b disposed in the slit portions 531. The slit portions 531 may have the same structure as the slit portions 131 described above. The insulating layers 15b may be resin plates or rubber plates disposed in the slit portions 531.

As with the magnetic field shaper 13 described above, an outer surface 532A of the magnetic field shaper 53 has a cylindrical shape corresponding to the shape of the conductor coil 12, but the cavity surface 535 of the end wall portion has a shape corresponding to the shape of the outer periphery of the first workpiece 40. Because the cavity surface 535 of the magnetic field shaper 53 has a shape corresponding to the outer periphery of the first workpiece 40, it is possible to locally apply an electromagnetic force to a portion to be processed of the first workpiece 40 and to compress the portion to be processed.

As described above, the electromagnetic forming coil device according to the present embodiment can be effectively used to clinch two pipe-shaped workpieces to each other. When clinching two pipe-shaped workpieces to each other, because the two workpieces overlap, in general, it is necessary to apply a stronger electromagnetic force to the portion to be processed than when processing one workpiece. Therefore, a conductor coil that can generate a stronger magnetic flux may be used. In this case, however, deformation of the portion not to be processed of the workpiece might occur. With the magnetic field shaper described above and the electromagnetic forming coil device including the magnetic field shaper, an electromagnetic force can be locally concentrated and deformation of the portion not to be processed can be suppressed. Therefore, the magnetic field shaper and the electromagnetic forming coil device can be more effectively used to clinch two pipe-shaped workpieces to each other.

The structures of the embodiments described above can be used in combination within the spirit and scope of the present invention.

What is claimed is:

1. An electromagnetic forming coil device comprising;
a conductor coil that is helically wound; and
a magnetic field shaper including
a tubular portion that is disposed in the conductor coil along the coil in a longitudinal direction, and
an end wall portion that extends from a base end portion thereof, which is at one end of the tubular portion in the longitudinal direction, to an extended end thereof toward an axis of the conductor coil, the end wall portion having a cavity surface at the extended end, the cavity surface surrounding a workpiece and being formed along an outer periphery of the workpiece,
wherein the tubular portion and the end wall portion of the magnetic field shaper are each divided into a plurality of sections in the longitudinal direction, and the magnetic field shaper includes insulating layers disposed on the divided sections of each of the tubular portion and the end wall portion and on the cavity surface, and
wherein the extended end of the end wall portion extending toward the axis is disposed at a position protruding outward from a position of the conductor coil in the longitudinal direction.

2. The electromagnetic forming coil device according to claim 1,
wherein the base end portion of the end wall portion is disposed so as to protrude outward from the position of the conductor coil in the longitudinal direction.

3. A method of making an electromagnetically formed product by using a magnetic field shaper including a tubular portion, an end wall portion, and insulating layers, the tubular portion being disposed in a conductor coil, which is helically wound, along the coil in a longitudinal direction, the end wall portion extending from a base end portion thereof, which is at one end of the tubular portion in the longitudinal direction, to an extended end thereof toward an axis of the conductor coil, the end wall portion having a cavity surface at the extended end, the cavity surface being formed along an outer periphery of the workpiece, the tubular portion and the end wall portion of the magnetic field shaper each being divided into a plurality of sections in the longitudinal direction, the insulating layers being disposed on the divided sections of each of the tubular portion and the end wall portion and on the cavity surface, the method comprising:
a step of arranging the magnetic field shaper and the workpiece so that the cavity surface surrounds a portion to be processed of the workpiece;
a step of disposing the conductor coil around the magnetic field shaper so that the extended end of the end wall portion is located at a position protruding outward from a position of the conductor coil in the longitudinal direction; and
a step of passing an electric current through the conductor coil to generate magnetic flux,
wherein the portion to be processed of the workpiece is processed by using an electromagnetic force generated by the magnetic flux.

4. The method of making an electromagnetically formed product according to claim 3,
wherein the conductor coil is disposed around the magnetic field shaper after the portion to be processed of the workpiece has been surrounded by the cavity surface of the magnetic field shaper.
